(19) United States
(12) Patent Application Publication
(10) Pub. No.: US 2003/0230024 A1
(43) Pub. Date: Dec. 18, 2003

(54) Marine mounted fishing pole holder

(76) Inventor: Jeffery Scott Roberson, Henderson, NC (US)

Correspondence Address: MILLS LAW FIRM, PLLC, 822 SOUTH WHITE STREET, SUITE 100, P.O. BOX 1088, WAKE FOREST, NC, 27588, US

(21) Appl. No.: 10/464,262

(22) Filed: Jun. 18, 2003

Related U.S. Application Data
(60) Provisional application No. 60/389,614, filed on Jun. 18, 2002.
(60) Provisional application No. 60/414,896, filed on Oct. 1, 2002.

(51) Int. Cl. A01K 97/10

(52) U.S. Cl. 43/21.2

(57) ABSTRACT

A fishing pole holder includes a hook having a stop bar attached transverse to the hook, having a vertically extending rod support system, a transversely attached cross bar at the upper end of the rod support system, and a plurality of cylindrical fishing pole sleeves attached at longitudinally spaced locations to the upper cross bar. The holder is readily mounted to a marine cleat as commonly found on boats or docks. A U-shaped hook may be used to secure the fishing pole holder to a boat rail.

### RELATED APPLICATIONS

This application claims the benefit under 35 USC 121 of U.S. Provisional Patent Application Nos. 60/389,614 filed on Jun. 18, 2002 and 60/414,896 filed on Oct. 1, 2002, both in the name of Jeffrey Scott Roberson.

### FIELD OF THE INVENTION

The present invention relates generally to a fishing rod holder suitable for use on a dock or a boat, and more particularly to an improved fishing rod holder that is removably attached to a marine site such as a cleat or a boat rail without the need for mechanical fasteners.

### BACKGROUND OF THE INVENTION

Many fishermen commonly deploy a plurality of fishing poles at a fishing location, such as a pier or a boat. A variety of pole holders are commercially available for fixed mounting of the poles. These pole holders oftentimes require the mechanical attachment of brackets and other devices for mounting oftentimes requiring alteration and possibly defacing of the mounting surface and deterring ready portability.

Many boats, piers, docks, and the like are equipped with conventional marine cleats for attaching mooring lines and the like. Many boats are provided with rails about the periphery. The present invention provides a fishing pole holder that may be securely, but removably, hooked over an existing cleat or boat rail. The holder carries fishing pole pods for carrying a plurality of fishing poles.

Examples of similar fishing pole holders are described in the following patents. U.S. Pat. No. 4,803,794, to Lopez, discloses a fishing pole holder for attachment to docks. The loop portion of a conventional threaded eyebolt inserts between the planks of a wooden dock. The loop rotates such that it engages the bottom of the wooden planks and prevents the eyebolt from being removed from the slot. The threaded portion of the eyebolt inserts into a hole in the base of a tubular rod holding assembly. A wing nut threaded onto the end of the threaded portion compresses the base of the rod holding assembly to the upper surface of the dock securing the rod holding assembly. The wing nut is loosened and the eye bolt is rotated to permit the loop to move through the slots between the planks allowing removal of the rod holding assembly. This invention is limited to use with docks with planks having slots therein at least as wide as the eye bolt. A disadvantage of this invention is that it requires a dock having planks with nominal spacing between the planks to mount the rod holder. Another disadvantage is that the eye bolt and wing nut are easily dropped into the water while trying to secure the holder to the dock. Mechanical fasteners are required for secure attachment to a dock.

U.S. Pat. No. 5,625,974, to Demaio, discloses a clever portable, dock-mounted fishing pole holder that attaches by inserting a stem with an upper and a lower crossbar between the planks. With the upper crossbar adjacent the upper dock surface and the lower crossbar adjacent the lower dock surface, the stem rotates such that the crossbars are perpendicular to the slots. The holder tilts toward the edge of the dock such that the upper and lower crossbars frictionally engage the upper and lower surfaces of the dock, respectively, securing the rod holder for use. If spacing between the planks is wider than expected, the stem has the potential for lateral movement, possibly reducing the stability of the holder. If the holder is inadvertently rotated by 90 degrees, whether by the weather elements or by human interaction, its lower crossbar will become disengaged from the dock and cause the rod, reel, and holder to fall into the lake or ocean. Moreover, if the holder is repetitively shaken as can happen with a fishing pole bobbing up and down while fishing, the holder can “walk” down the planks until it reaches the end of the pier and then falls into the lake or ocean. A second embodiment of the invention includes a bent stem that is lowered between the dock planks and rotated 90 degrees to engage the lower surface of the dock. An upper crossbar and the lower bent stem frictionally engage the engage the upper and lower surfaces of the dock, respectively, security the rod holder for use. A disadvantage of this invention is that it must with a dock having properly spaced slots between its planks. Moreover, if spacing between the planks is wider than expected, the upper crossbar may fall into the slot, disengage from the upper dock surface, and become rotationally unstable.

U.S. Pat. No. 6,497,067, to King, discloses yet another holder for mounting on the edge of a fishing pier or dock that includes a long bolt extending through a tubular housing and through holes in upper and lower retainer plates at the lower end of the bolt. The lower retainer plate is sufficiently narrow to allow it to slide between the planks of a dock and rotate perpendicularly to the slot to engage the lower surface of the dock. The upper retainer plate is wider than the slot and is compressed against the upper surface of the dock to hold the reel holder in place. A disadvantage of this invention, like the previous dock-mounted reel holders discussed, is its limitation for use with docks having particular spacing between the planks. Mechanical fasteners are required for secure attachment to a dock.

U.S. Pat. No. 6,088,946, to Simmons, discloses a fishing pole holder with a plurality of mounting supports, including clamping plates for attaching the holder to a dock, pier, or boat, a tripod support for mounting the holder in the ground, a jetty rod support for mounting the holder between large rocks, and an ice screw support for mounting the holder on ice. Common to each mounting support is the requirement for attachment with threaded studs with wing nuts. While this invention overcomes the requirement for a dock with appropriately spaced planks, none of the disclosed methods of attachment lends itself for attachment to marine cleats or boat railings. As with previous inventions, mechanical fasteners are required for secure attachment to a dock.

Positioning of other rod holders is accomplished in many fashions. Briefly, for example, the fishing rod holder assembly disclosed in U.S. Pat. No. 6,216,998, to Butrymowicz et al., is positioned or mounted by a spike inserted into the ground.

The boat fishing pole and line holder disclosed in U.S. Pat. No. 4,753,029, to Shaw et al., is a trolling assembly that is permanently secured to the deck of a boat by means of a base plate that is screwed or otherwise mechanically fastened to the boat deck.

The fishing rod support device disclosed in U.S. Pat. No. 6,438,889, to Handy, includes a plurality of at least three leg members supporting the stand assembly that are not affixed to the essentially horizontal planar surface required for stable positioning. The horizontal surface area required to accommodate the leg members may not be available in locations in which a fisherman would like to use the device.

The fishing pole holder disclosed in U.S. Pat. No. 4,901,970, to Moss et al., has a tubular sleeve into which a pole handle is inserted that is positioned for use by a mounting block that is clamped about a boat rail and secured with machine screws. The mounting block requires a hand tool such as a screwdriver or wrench for attachment to a rail as well as access to the underside of the block to tighten the screws, thereby limiting the locations in which the holder can be installed. Mechanical fasteners are required for secure attachment.

The fishing rod holder disclosed in U.S. Pat. No. 6,381,897, to Walsh, holds multiple rods, but it must be permanently mounted to a hard top, radar arch, or other overhead structure of a boat using mechanical fasteners.

None of these inventions either singly or in combination meets the needs of the fisherman who desires to temporarily yet securely affix a fishing rod holder to a marine cleat or boat railing readily available on most docks and boats.

### BRIEF SUMMARY OF THE INVENTION

The present invention provides a fishing rod holder that can be temporarily but securely affixed to a variety of articles proximate to a person fishing from a dock or a boat. In the preferred embodiment, the pole holder includes a rod support stem having a reversely bent hook at a lower end and a rod cross bar symmetrically transversely attached at an upper end. One or more outwardly extending fishing pole sleeves are attached to the upper cross bar at longitudinally spaced locations. The support stem is easily inserted into a conventional marine cleat as found either on a boat or a dock. The unique design of the support stem and stop bar together with the weight of the fishing pole sleeves and fishing rods creates a torqued coupling that establishes a mechanically fixed attachment that resists unloosening or dislodgement. As marine cleats are commonly available marine commodity items, a suitable mounting for the present invention can be added to virtually any dock or boat surface by the addition of a simple cleat. Such additions will not detract from the physical appearance of the boat, are simple to install, and are very inexpensive to purchase.

In an alternate embodiment, the hook and stop bar are replaced by a U-shaped hook that slips over a standard boat rail for stably attaching the pole holder to a rail. If greater compressive and frictional resistance at the mounting location are desired, an elastomeric sheet or strip may be interposed between the rail and the inner surfaces of the hook to increase resistance to movement.

Accordingly, it is an object of the invention to provide a fishing rod holder for one or more fishing rods that may be temporarily yet securely affixed to a cleat on a boat or deck surface.

Another object of the invention is to provide a fishing rod holder for one or more fishing rods that may be temporarily yet securely affixed to a rail on a boat.

A further object of the invention is to provide a fishing rod holder for two or more fishing rods that angularly positions the fishing rods such that separation between the fishing lines is maintained such that they do not become entangled with each other.

### DESCRIPTION OF THE DRAWINGS

The above and other features and advantages of the present invention will become apparent upon reading the following detailed description taken in conjunction with the accompanying drawings of a pole holder in accordance with embodiments of the invention as shown in the attached drawings wherein:

FIG. 1 is a front elevational view of a pole holder mounted on a marine cleat in accordance with an embodiment of the invention;

FIG. 2 is a side elevational view of the center sleeve of the pole holder of FIG. 1;

FIG. 3 is a front elevational view of another embodiment of the pole holder;

FIG. 4 is a perspective view of the pole holder of FIG. 1 mounted on a cleat at a dock location;

FIG. 5 is a top perspective view of a pole holder of FIG. 3 mounted on a gunnel of a boat;

FIG. 6 is a front perspective view of a pole holder of FIG. 3 mounted on the gunner of the boat of FIG. 5;

FIG. 7 is a side elevational view of a pole holder in accordance with a further embodiment mounted on a boat rail;

FIG. 8 is a front elevational view of the pole holder of FIG. 7; and FIG. 9 is a rear view of a pole holder of FIG. 7 mounted on a boat rail.

### DETAILED DESCRIPTION OF THE PREFERRED EMBODIMENTS

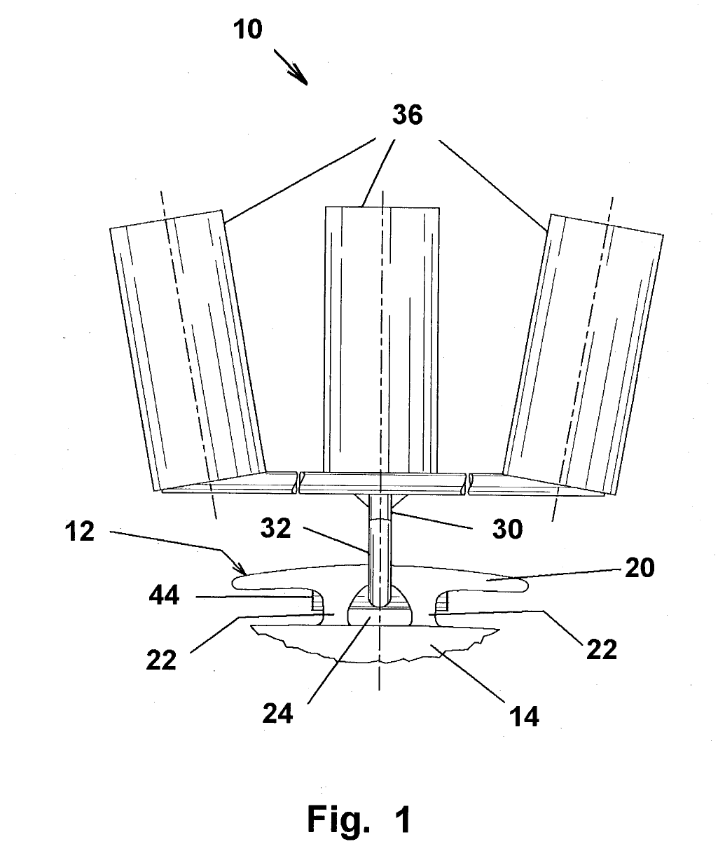

Referring to the drawings, FIG. 1 shows one embodiment wherein a fishing pole holder 10 is removably attached at a marine location to a conventional marine cleat 12 attached at a fishing location surface 14, such as a boat deck, pier or the like.

The cleat 12 is characterized by a cleat cross bar 20 attached to the location surface 14 by a pair of spaced mounting legs 22 defining therebetween a central opening 24. Typical cleats are widely commercially available and commonly found at the above locations.

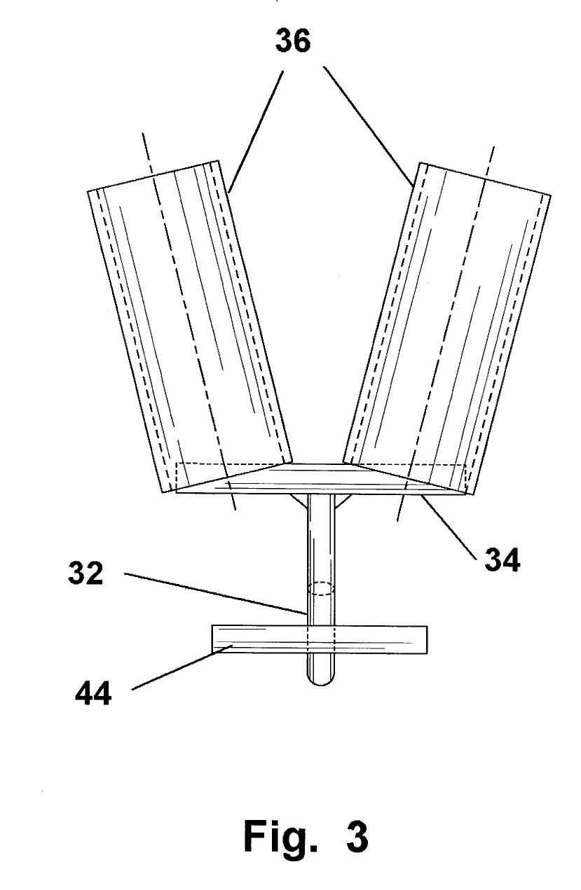

The pole holder 10 includes a J-shaped support stem 30 formed from cylindrical metal rod. The stem has a reversely bent U-shaped hook 32 at a lower end. A cylindrical rod upper cross bar 34 is symmetrically transversely attached at an upper end. A plurality of cylindrical fishing pole sleeves 36 are attached at longitudinally spaced locations to the upper cross bar 34. In the embodiment of FIGS. 1, 2 and 4, three sleeves are provided. In the embodiment of FIGS. 3, 5 and 6, two sleeves are provided. A greater or lesser number may be employed as desired. The outboard sleeves may be angularly outwardly inclined with respect to the support stem 30 or may be aligned normal thereto.

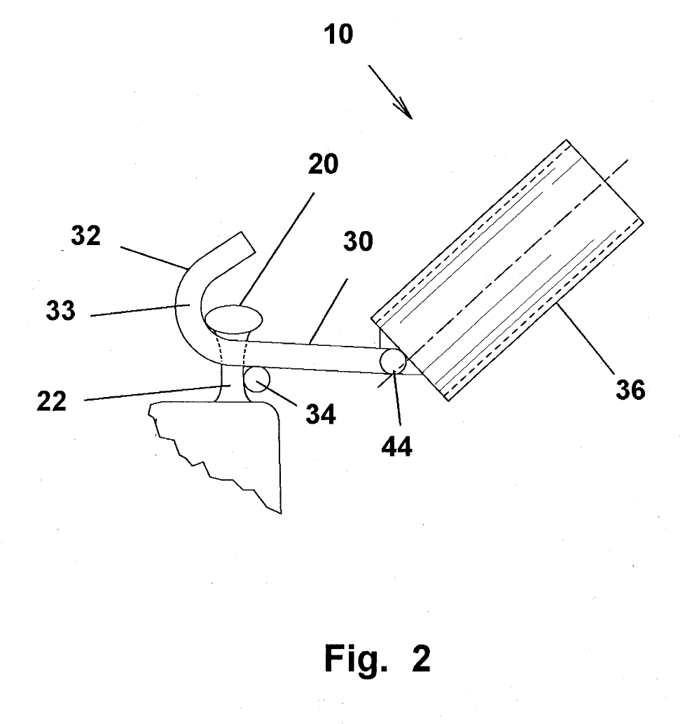

Referring additionally to FIG. 2, sleeves 36 are disposed at a shallow angle with respect to the axis of the stem 30. The hook 32 of the support stem 30 extends vertically. The hook 32 extends through the opening 24 between the legs 22 of the cleat 12 and includes a curved base 33 having an inner surface that engages the rear surface of the cross bar 20 of the cleat 12. A cylindrical stop bar 44 is symmetrically attached transverse to the hook 32 and parallel to the upper cross bar 34 at an intermediate portion of the stem. With the hook 32 inserted through the opening 24 between the legs 22 of the cleat 12 and hooked over the cleat cross bar 20 of the cleat 12, the stop bar 44 compressively engages the front rear surface of the cleat legs 22 under the offset weight of the holder 10 to removably attach the holder thereto. The length of the stop bar 44 is greater that the leg spacing to ensure secure mounting contact. The engagement between the base 33 and the cleat cross bar 20 prevents forward movement. Under static load or dynamic load during fishing, the cantilevered weight of the sleeves 36 and associated poles creates a torsional camming engagement with the cleat, increasing as the loading increases.

The upper cross bar 34 of the holder traverses the lower open ends of the sleeves 36 and forms a base for supporting the lower ends of the poles. Preferably, the sleeves 36 are cylindrical with an inner diameter of around 1.5 inches thereby accommodating the vast majority of available fishing poles.

By inclining the support stem 30 about 10 to 30 degrees with respect to the sleeve axis, the deployed fishing poles are stably supported at the fishing location. By outwardly inclining the sleeves 36 about 10 to 40 degrees with respect to the stem, acceptable separation of the attendant fishing lines is provided.

Preferably, the holder 10 comprises a weldments assembly integrating the support stem 30, the upper cross bar 34, the stop bar 44, and the bases of the sleeves 36. The assembly is preferably provided with a corrosion resistant coating. To prevent marring of the cleat 12, the support stem and the hook 32 may be coated with an elastomeric material.

Referring to FIG. 3, the pole holder 10 may be provided with a pair of outwardly inclined sleeves 36 symmetrically disposed on the cross bar 34.

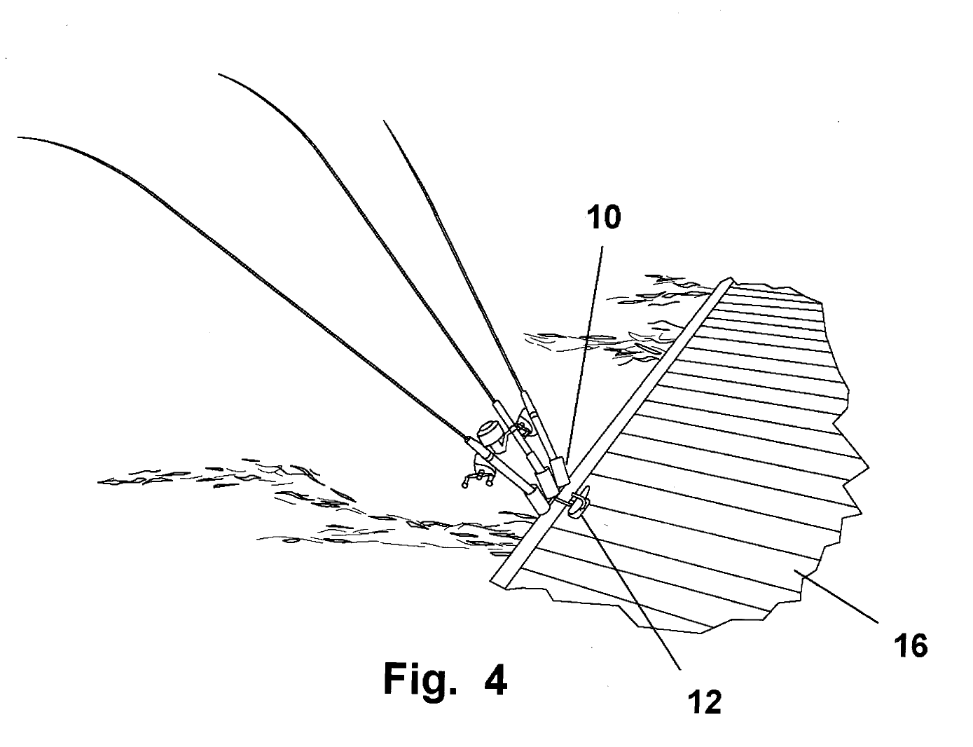

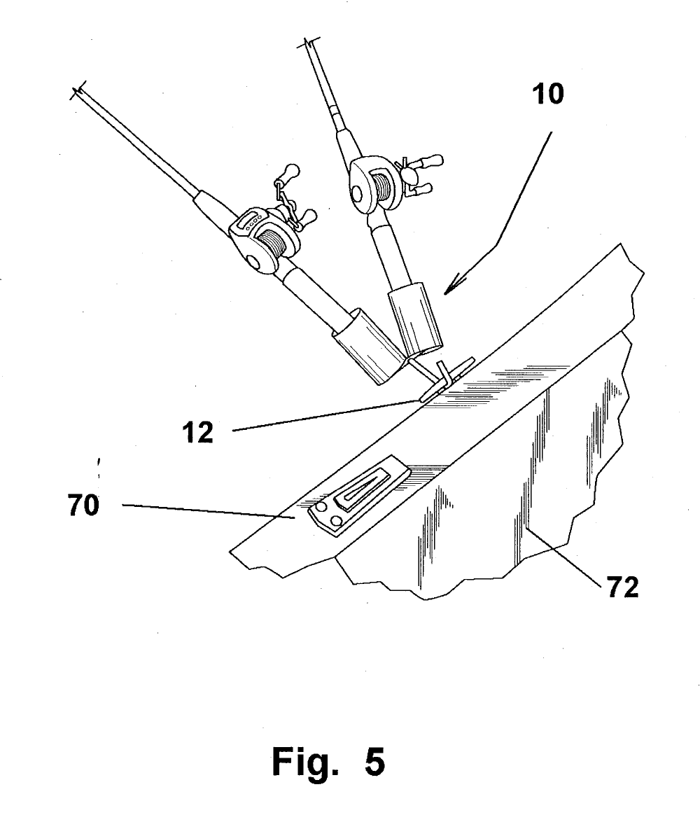

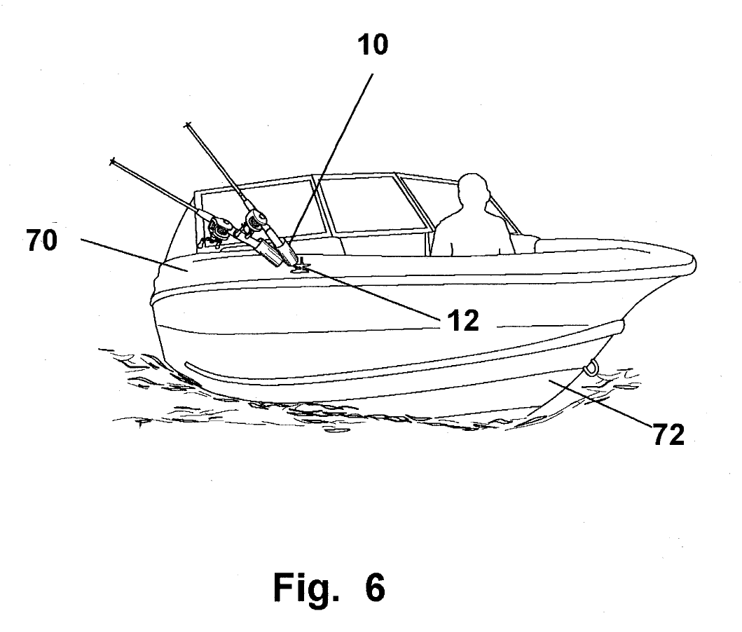

The pole holder may deploy in a variety of typical fishing locations as show in FIGS. 4 through 7. In FIG. 4, the pole holder of FIGS. 1 and 2 is supported on a cleat 12 attached at a pier 60. In FIGS. 5 and 6, the pole holder 10 is supported on a cleat 12 carried on the gunnel 70 of a fishing boat 72.

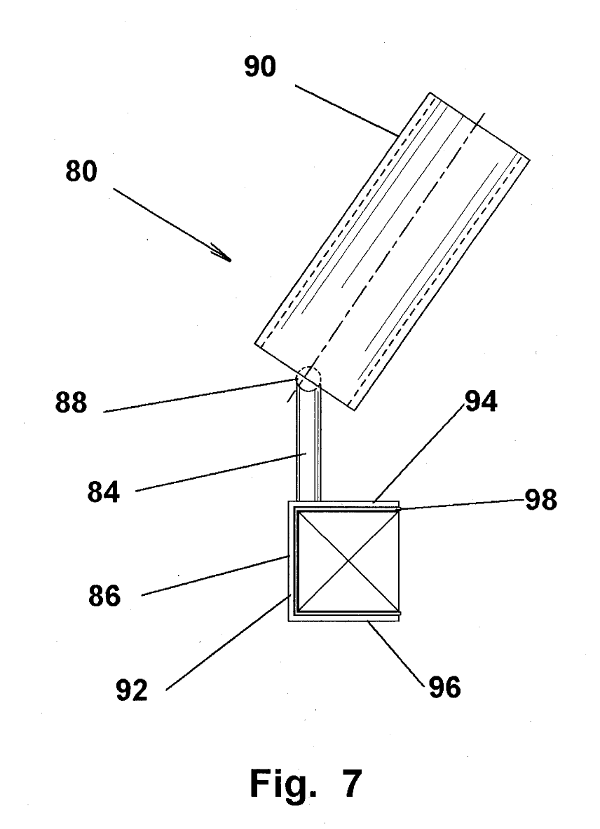

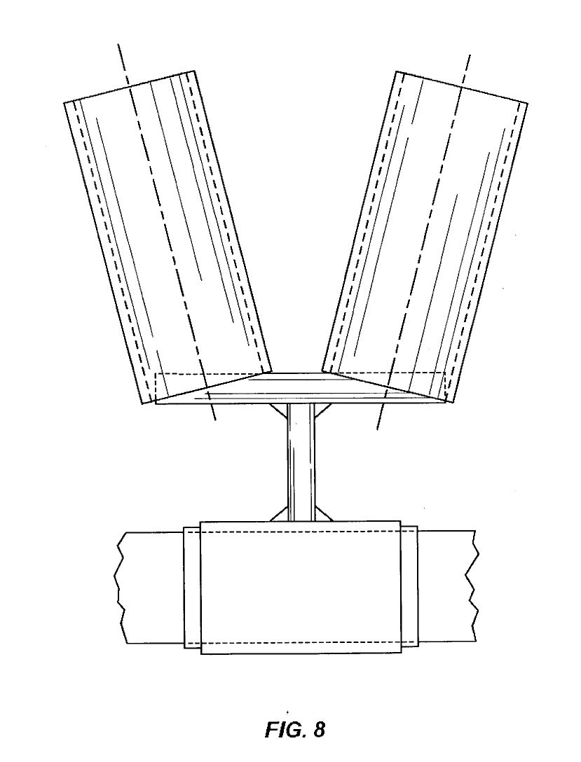

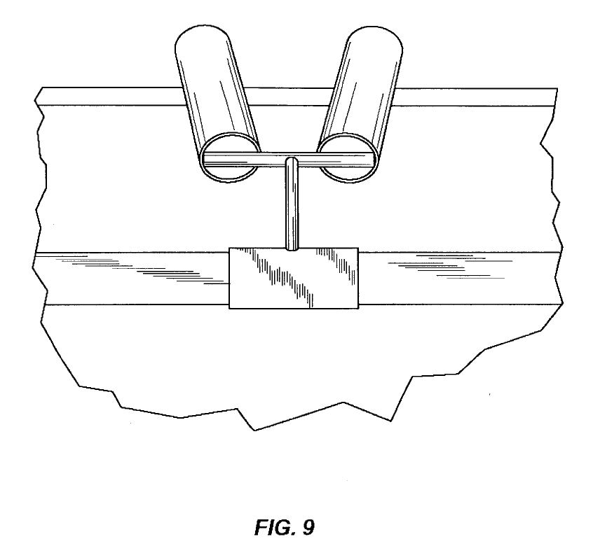

Referring to FIGS. 7 through 9, another embodiment of the holder is shown for mounting at a marine location a pole holder 80 on a boat guard rail 82.

The boat rail 82 is commonly found on many marine water craft and positioned at locations around the periphery thereof. The rail 82 is generally rectangular tubing carried on spaced mounting legs.

The pole holder 80 includes a cylindrical rod support stem 84 attached at a lower end to a U-shaped hook 86 and symmetrically transversely attached at an upper end to an upper cross bar 88. A pair of cylindrical fishing pole sleeves 90 are attached at longitudinally spaced locations to the upper cross bar 88. As in the above described embodiments a greater or lesser number may be employed. The sleeves 90 angularly diverge outwardly with respect to the support stem 60 or alternatively may be aligned parallel therewith.

The sleeves 90 are disposed at an angle with respect to the axis of the stem 84. The hook 86 comprises a section of rectangular tubing having one wall removed to form a U-shaped cross section having a vertical base wall 92 and vertically spaced, horizontal top and bottom walls, 94 and 96 respectfully. In assembly, the hook 86 is slid outwardly onto the rail 82 with the base wall 92 engaging the inner surface of the rail and the walls 72 and 74 engaging the upper and lower surfaces thereof. As in the previously described embodiment, the weight and orientation of the sleeves will effect a torsional locking engagement with the rail surfaces under static and kinetic loading. The base wall 92 directly engaging the rail to prevent movement therebetween. To provide greater compressive and frictional resistance at the mounting location, an elastomeric sheet or strip 98 may be provided at the interface between the rail and the inner surfaces of the hook.

Preferably, the pole holder 80 comprises a weldments assembly integrating the support stem, the upper cross bar, and the sleeves. The pole holder is preferably provided with a corrosion resistant coating or formed of corrosion resistance material.

The pole holder 80 may deploy in a variety of typical fishing locations such as the rail 100 of the boat as shown in FIG. 9.

Having thus described a presently preferred embodiment of the present invention, it will now be appreciated that the objects of the invention have been fully achieved, and it will be understood by those skilled in the art that many changes in construction and widely differing embodiments and applications of the invention will suggest themselves without departing from the sprit and scope of the present invention. The disclosures and description herein are intended to be illustrative and are not in any sense limiting of the invention, which is defined solely in accordance with the following claim.

What is claimed:

1. A fishing pole holder for attachment to a marine site at a fishing location wherein the marine site is characterized by an upper cross bar having a pair of spaced support surfaces attached to the location and defining therebetween the mounting site, said pole holder comprising: a support stem; an upper cross bar transversely attached to an upper end of said support stem; a mounting hook at the lower end of said support stem having spaced engagement surfaces for contacting the support surfaces of the upper cross bar and a rear engagement surface for contacting the upper cross bar to prevent outward movement; at least one cylindrical pole holding sleeve attached to said upper cross bar and having an outwardly opening cavity for carrying the handle of a fishing pole, said sleeve being inclined outwardly from said support stem with the weight thereof providing positive torsional engagement between said engagement surfaces and the support surfaces.

2. A fishing pole holder for stable mounting on a marine cleat having a cross member attached at a fishing location by a pair of spaced feet defining an opening therebetween, the fishing pole holder comprising: a J-shaped hook member formed of cylindrical rod a having an upper straight stem and a lower reversely curved base; a cylindrical upper cross member transversely symmetrically attached to an upper end of said stem; a cylindrical intermediate cross member attached to an intermediate portion of said stem and parallel to said stem, the arrangement being such that said stem extends through said opening and the base engages cross member of the cleat and the intermediate cross member engages the front surfaces of the legs of the cleat in a mounting position thereon; and a plurality of cylindrical sleeves attached to said upper cross member and having outwardly opening cavities for carrying the handles of fishing poles, said sleeves inclined upwardly and outwardly at a shallow angle with respect to said stem whereby the weight of the sleeves and poles provides positive torsional engagement between said hook and said cleat.

3. The pole holder as recited in claim 2 wherein three sleeves are attached symmetrically at said upper cross member.

4. The pole holder as recited in claim 3 wherein the outer sleeves are outwardly inclined with respect to said stem.

5. The pole holder as recited in claim 2 wherein a pair of sleeves are symmetrically attached at said upper cross member.

6. A fishing pole holder for mounting on a marine craft at a guard rail formed of rectangular tubing, said pole holder comprising: a cylindrical stem having a transverse cross bar attached at an upper end and a U-shaped hook at a lower end, said hook in a mounting position having vertically spaced planar upper and lower surfaces for sliding compressive engagement with the upper and lower surfaces of the guard rail and a rear surface for engagement with the rear surface of the guard rail thereby preventing forward movement from said mounting position; and a plurality of cylindrical sleeves having cavities for receiving fishing poles attached to said transverse cross bar and inclined upwardly and outwardly from said stem whereby the weight of said sleeves and said poles provides a positive torsions engagement a between said hook and said guard rail in the mounting position.

7. The fishing pole holder as recited in claim 6 wherein a compressible sheet is interposed between said hook and said guard rail to increase the compressive and frictional engagement therebetween.

8. The fishing pole holder as recited in claim 7 wherein said stem is vertically attached said upper surface of a hook adjacent said rear surface. marine
